(19) United States
(12) Patent Application Publication
(10) Pub. No.: US 2024/0144739 A1
(43) Pub. Date: May 2, 2024

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Tomoyuki KOZUKA, Toyota-shi Aichi-ken (JP)

(73) Assignee: TOYOTA JIDOSHA KABUSHIKI KAISHA, Toyota-shi Aichi-ken (JP)

(21) Appl. No.: 18/385,011

(22) Filed: Oct. 30, 2023

(30) Foreign Application Priority Data
Nov. 1, 2022 (JP) 2022-175756

(51) Int. Cl. G07C 5/00

(52) U.S. Cl. CPC G07C 5/008

(57) ABSTRACT

An information processing apparatus capable of communicating with a management server includes a controller configured to execute operations, the operations including acquiring sensor information from a sensor installed in a vehicle, and upon detecting, from the sensor information, an abnormality in the vehicle, notifying the management server of the content of the abnormality.

### CROSS-REFERENCE TO RELATED APPLICATION

This application claims priority to Japanese Patent Application No. 2022-175756, filed on Nov. 1, 2022, the entire contents of which are incorporated herein by reference.

### TECHNICAL FIELD

The present disclosure relates to an information processing apparatus, an information processing method, and a program.

### BACKGROUND

Technology in which, when abnormal conditions having difficulty in manual operations by occupants (drivers) are detected, remote operation apparatuses are notified to secure remote operators is known. For example, see Patent Literature (PTL) 1.

### CITATION LIST

### Patent Literature

PTL 1: JP 2021-015561 A

### SUMMARY

In the above technology, abnormal conditions are detected only for drivers.

It would be helpful to assist quick and appropriate decisions on abnormalities.

An information processing apparatus according to an embodiment of the present disclosure is an information processing apparatus capable of communicating with a management server, the information processing apparatus including a controller configured to execute operations, the operations including:

acquiring sensor information from a sensor installed in a vehicle; and

upon detecting, from the sensor information, an abnormality in the vehicle, notifying the management server of the content of the abnormality.

An information processing method according to an embodiment of the present disclosure is an information processing method by an information processing apparatus capable of communicating with a management server, the information processing method including:

acquiring sensor information from a sensor installed in a vehicle; and

upon detecting, from the sensor information, an abnormality in the vehicle, notifying the management server of the content of the abnormality.

A program according to an embodiment of the present disclosure is configured to cause a computer, as an information processing apparatus capable of communicating with a management server, to execute operations, the operations including:

acquiring sensor information from a sensor installed in a vehicle; and

upon detecting, from the sensor information, an abnormality in the vehicle, notifying the management server of the content of the abnormality.

According to an embodiment of the present disclosure, quick and appropriate decisions on abnormalities by managers can be assisted.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of a management server;

FIG. 3 is a block diagram illustrating a configuration of a vehicle;

FIG. 4 is a sequence diagram illustrating operations of the information processing system; and

FIG. 5 is a diagram illustrating a data structure of an abnormality-related information database (DB).

### DETAILED DESCRIPTION

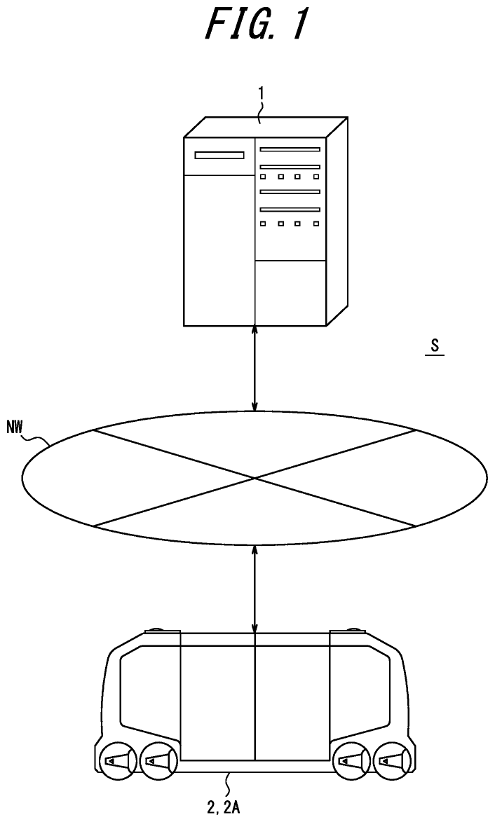

FIG. 1 is a schematic diagram of an information processing system S according to the present embodiment. The information processing system S includes a management server 1 and a vehicle 2. The management server 1 can communicate with the vehicle 2 via a network NW. The network NW includes, for example, a mobile communication network, the Internet, or a fixed communication network.

FIG. 1 illustrates one of the management server 1 and one of the vehicle 2, for convenience of explanation. However, the number of management servers 1 and the number of vehicles 2 are not limited to this. For example, processing executed by the management server 1 may be executed by a plurality of distributed management servers 1. The management server 1 may be capable of communicating with a plurality of vehicles 2.

An outline of processing executed by an information processing apparatus 2A of the present embodiment will be described. A controller 21 of the information processing apparatus 2A executes operations that include acquiring sensor information from a sensor 24 installed in the vehicle 2, and upon detecting, from the sensor information, an abnormality in the vehicle 2, notifying the management server 1 of the content of the abnormality. This configuration allows the information processing apparatus 2A to quickly notify a manager who performs remote monitoring and the like, of the abnormality in the vehicle 2. Thus, the information processing apparatus 2A can assist the manager in making a quick and appropriate decision on the abnormality. Furthermore, the information processing apparatus 2A can assist in smooth processing for escalation by the manager.

The management server 1 may be a server configured to assist a

provider in providing a service. The management server 1 may be installed, for example, in a control center, an operation management center, a remote monitoring center, a business management center, a facility dedicated to an operator, or a shared facility including a data center. The management server 1 may be referred to as a center server. As an alternative example, the management server 1 may be mounted in the vehicle 2.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

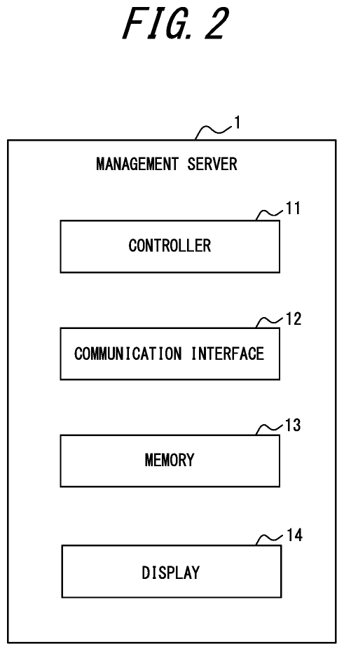

With reference to FIG. 2, an internal configuration of the management server 1 will be described in detail.

The management server 1 includes a controller 11, a communication interface 12, a memory 13, and a display 14. The components of the management server 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes, for connecting to a network, one or more communication modules that conform to wired or wireless LAN (Local Area Network) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information regarding operations and control of the management server 1. The memory 13 may store a system program, an application program, embedded software, and the like. The memory 13 may be provided outside the management server 1 and accessed by the management server 1. The memory 13 includes an abnormality-related information DB.

The display 14 is, for example, a display. The display is, for example, an LCD or an organic EL display. The term “LCD” is an abbreviation of liquid crystal display. The term “EL” is an abbreviation of electro luminescence. The display 14, instead of being included in the management server 1, may be connected to the management server 1 as an external output device. As a connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

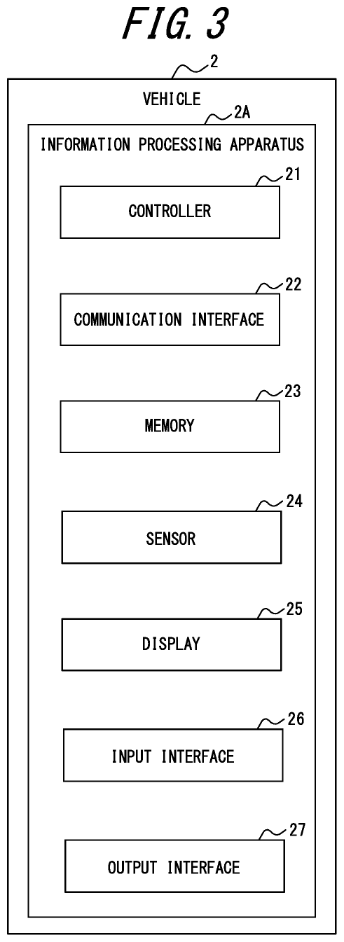

In FIG. 3, an internal configuration of the vehicle 2 will be described in detail.

By way of example, the information processing apparatus 2A is installed in the vehicle 2. As an alternative example, the information processing apparatus 2A may be provided outside the vehicle 2.

The information processing apparatus 2A includes the controller 21, a communication interface 22, a memory 23, the sensor 24, a display 25, an input interface 26, and an output interface 27. The components of the information processing apparatus 2A are communicably connected to one another via, for example, dedicated lines.

Descriptions of the hardware configurations of the controller 21, the communication interface 22, the memory 23, and the display 25 may be the same as the descriptions of the hardware configurations of the controller 11, the communication interface 12, the memory 13, and the display 14, respectively. A description here is omitted.

The vehicle 2 according to the present embodiment performs automated driving. The memory 23 of the vehicle 2 stores Autonomous Driving Kit (ADK) software for the automated driving and conductor software.

The sensor 24 is installed in the vehicle 2. The sensor 24 includes an image sensor of a camera, and captures images. The images may be either still images or moving images. The sensor 24 may generate the images and record the generated images in the memory 23. The sensor 24 may include a camera to assist in remote operations of the vehicle 2 and a surveillance camera for a conductor.

The sensor 24 may be a door sensor that detects whether a person is caught in a door of the vehicle 2. The sensor 24 may be a millimeter wave sensor.

The display 25 may be a signage. The display 25 may be a touch panel.

The input interface 26 is, for example, a microphone, a physical key, a capacitive key, a pointing device, or a touch screen integrally provided with a display. The input interface 26 accepts an operation for inputting information to be used for the operations of the vehicle 2. The input interface 26 may be connected to the vehicle 2 as an external input device, instead of being provided in the vehicle 2. As a connection method, any technology such as USB, HDMI®, or Bluetooth® can be used.

The output interface 27 includes at least one output interface for outputting information to notify a user of the information. For example, the output interface included in the output interface 27 is a speaker for outputting the information in the form of audio, or the like, but is not limited to this. For example, the output interface 27 may be any broadcast device.

As an additional example, the vehicle 2 may include a calling device for calls between passengers and an operator of the management server 1. The vehicle 2 may further include various buttons for bus operations.

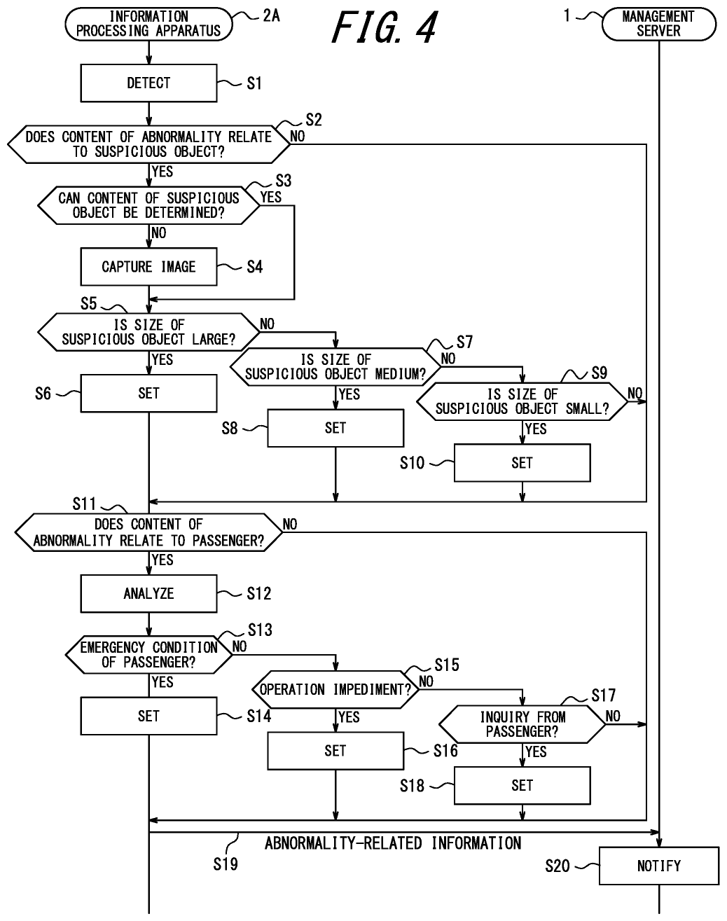

Hereinafter, as illustrated in FIG. 4, processing executed by the information processing system S according to the present embodiment will be described in detail. As an example here, one or more vehicles 2 are operated as automated buses. The management server 1 installed in a center monitors the one or more vehicles 2. The number of vehicles to be monitored can be set appropriately.

In step S1, the controller 21 of the information processing apparatus 2A acquires sensor information (here, captured images) from an in-vehicle camera as the sensor 24, and analyzes the captured images. The controller 21 detects an abnormality in the vehicle 2 from an analysis result.

In step S2, the controller 21 determines whether the content of the detected abnormality relates to a suspicious object. When No is selected in step S2, the controller 21 performs step S11 described below.

When Yes is selected in step S2, the controller 21 determines in step

S3 whether the content (e.g., an explosive, liquid, or the like) of the suspicious object can be determined. When Yes is selected in step S3, the controller 21 performs step S5 described below.

When No is selected in step S3, the controller 21 captures an enlarged

image of the suspicious object in step S4 by adjusting the orientation, viewing angle, and/or zoom (magnification or reduction) level of the camera.

In step S5, the controller 21 determines the size of the suspicious object. As an example here, the controller 21 determines whether the size is “large”. When Yes is selected in step S5, the controller 21 sets urgency at “high” in step S6.

Distinctions of the urgency can be set appropriately. As an example here, the urgency is set to “high” when human life and safety are involved. The urgency is set to “medium” when operations or passengers' sense of security are involved. The urgency is set to “low” when an errand is involved.

When No is selected in step S5, the controller 21 determines in step S7 whether the size of the suspicious object is “medium”. When Yes is selected in step S7, the controller 21 sets the urgency at “medium” in step S8.

When No is selected in step S7, the controller 21 determines in step S9 whether the size of the suspicious object is “small”. When Yes is selected in step S9, the controller 21 sets the urgency at “low” in step S10. When No is selected in step S9, the controller 21 performs step S11.

In step S11, the controller 21 determines whether the abnormality detected in step S1 relates to a passenger in the vehicle 2.

When No is selected in step S11, the controller 21 performs step S19 described below.

When Yes is selected in step S11, the controller 21 analyzes the condition of the passenger in step S12 using sensor information acquired from the sensor 24. The condition of the passenger includes, for example, at least one of the following:
Age
Gender
Posture
Behavior
Vitals (e.g., pulse rate, blood pressure, respiratory rate)

The age or gender may be determined from commuter pass information on the passenger. The vitals may be determined from sensors worn by the passenger, assuming the passenger has approved.

In step S13, the controller 21 determines whether the content of the abnormality is an emergency condition of the passenger. The emergency condition of the passenger includes, for example, any of the following:
The passenger is down.
The passenger is caught in a door.
The passenger is hyperventilating.

When Yes is selected in step S13, the controller 21 sets the urgency at “high” in step S14.

When No is selected in step S13, the controller 21 determines in step S15 whether the content of the abnormality is an operation impediment. The operation impediment includes, for example, any of the following:
The vehicle 2 cannot depart because the passenger does not take a seat.
The passenger is causing trouble with another passenger.

When Yes is selected in step S15, the controller 21 sets the urgency at “medium” in step S16.

When No is selected in step S15, the controller 21 determines in step S17 whether the content of the abnormality is an inquiry from the passenger. For example, upon detecting that the passenger has made two or more waving motions, the controller 21 may determine that the content of the abnormality is the inquiry from the passenger. When Yes is selected in step S17, the controller 21 sets the urgency at “low” in step S18. When No is selected in step S17, the controller 21 performs step S19 described below.

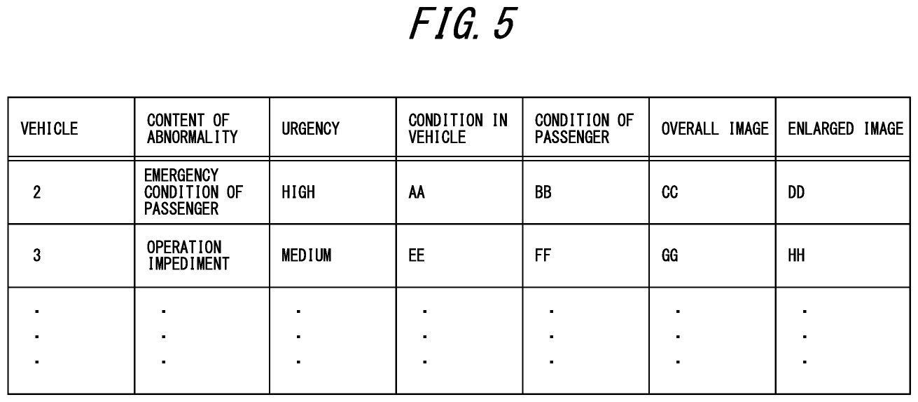

As illustrated in FIG. 5, at any given time, the controller 21 stores abnormality-related information in the memory 23 in associated with each vehicle. The vehicle-related information includes at least one of the following:
Content of abnormality
Urgency
Condition in vehicle (e.g., size of suspicious object)
Condition of passenger
Overall image
Enlarged image

In step S19, the controller 21 notifies the management server 1 of the abnormality-related information. The notification is also referred to as escalation. The management server 1 stores the abnormality-related information in the memory 13.

In step S20, the management server 1 receives the abnormality-related information. When the management server 1 has received a plurality of types of abnormality-related information from a plurality of vehicles 2, the management server 1 may notify a remote observer of the abnormality-related information according to the levels of urgency. The notification may be, for example, display via the display 14 or audio output via a speaker.

As an alternative example, the processes from step S2 to step S10 and the processes from step S11 to step S18 may be performed in reverse order. For steps S13, S15, and S17, which steps are performed in what order can be set appropriately.

As described above, according to the present embodiment, the controller 21 of the information processing apparatus 2A executes operations that include acquiring sensor information from the sensor 24 installed in the vehicle 2, and upon detecting, from the sensor information, an abnormality in the vehicle 2, notifying the management server 1 of the content of the abnormality. This configuration allows the information processing apparatus 2A to quickly notify a manager who performs remote monitoring and the like, of the abnormality in the vehicle 2. Thus, the information processing apparatus 2A can assist the manager in making a quick and appropriate decision on the abnormality. Furthermore, the information processing apparatus 2A can assist in smooth processing for escalation by the manager.

According to the present embodiment, the content of the abnormality relates to a suspicious object, an emergency condition of a passenger, an operation impediment, and/or an inquiry from a passenger. Furthermore, according to the present embodiment, the sensor 24 includes an image sensor, a door sensor, and/or a millimeter wave sensor. With this configuration, the information processing apparatus 2A can detect various abnormalities.

According to the present embodiment, the sensor 24 includes a camera, and the operations of the controller 21 include, upon determining that the content of the abnormality is a suspicious object and that the content of the suspicious object cannot be determined, capturing an enlarged image of the suspicious object by adjusting the orientation, viewing angle, and/or zoom level of the camera, and notifying the management server 1 of the enlarged image. With this configuration, the information processing apparatus 2A can further assist the manager in making the decision.

According to the present embodiment, the operations of the controller 21 also include, upon determining that the content of the abnormality relates to a passenger, analyzing the condition of the passenger and notifying the management server 1 of the condition of the passenger. The condition of the passenger includes the age, gender, posture, behavior, pulse rate, blood pressure, and/or respiratory rate of the passenger. With this configuration, the information processing apparatus 2A can further assist the manager in making the decision.

According to the present embodiment, the operations of the controller 21 also include determining urgency from the size of the suspicious object and/or the condition of the passenger, and notifying the management server 1 of the urgency. With this configuration, the information processing apparatus 2A can further assist the manager in making the decision.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each component or each step can be rearranged without logical inconsistency, and a plurality of components or steps can be combined into one or divided.

For example, in the above embodiment, a program that executes all or some of the functions or processing of the information processing apparatus 2A can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from the server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Examples of some embodiments of the present disclosure are described below. However, it should be noted that the embodiments of the present disclosure are not limited to these examples.
[Appendix 1] An information processing apparatus capable of communicating with a management server, the information processing apparatus comprising a controller configured to execute operations, the operations comprising:
   acquiring sensor information from a sensor installed in a vehicle; and
   upon detecting, from the sensor information, an abnormality in the vehicle, notifying the management server of a content of the abnormality.
[Appendix 2] The information processing apparatus according to appendix 1, wherein the content of the abnormality relates to a suspicious object, an emergency condition of a passenger, an operation impediment, and/or an inquiry from a passenger.
[Appendix 3] The information processing apparatus according to appendix 1 or 2, wherein the sensor includes an image sensor, a door sensor, and/or a millimeter wave sensor.
[Appendix 4] The information processing apparatus according to any one of appendices 1 to 3, wherein
   the sensor includes a camera, and
   the operations comprise:
      upon determining that the content of the abnormality is a suspicious object and that a content of the suspicious object cannot be determined, capturing an enlarged image of the suspicious object by adjusting an orientation, viewing angle, and/or zoom level of the camera; and
      notifying the management server of the enlarged image.
[Appendix 5] The information processing apparatus according to any one of appendices 1 to 4, wherein the operations comprise:
   upon determining that the content of the abnormality relates to a passenger, analyzing a condition of the passenger; and
   notifying the management server of the condition of the passenger.
[Appendix 6] The information processing apparatus according to appendix 5, wherein the condition of the passenger includes an age, gender, posture, behavior, pulse rate, blood pressure, and/or respiratory rate of the passenger.
[Appendix 7] The information processing apparatus according to appendix 2, wherein the operations comprise notifying the management server of urgency by determining the urgency from a size of the suspicious object and/or a condition of the passenger.
[Appendix 8] A vehicle having the information processing apparatus according to appendix 1 mounted therein.
[Appendix 9] An information processing method by an information processing apparatus capable of communicating with a management server, the information processing method comprising:
   acquiring sensor information from a sensor installed in a vehicle; and
   upon detecting, from the sensor information, an abnormality in the vehicle, notifying the management server of a content of the abnormality.
[Appendix 10] The information processing method according to appendix 9, wherein the content of the abnormality relates to a suspicious object, an emergency condition of a passenger, an operation impediment, and/or an inquiry from a passenger.
[Appendix 11] The information processing method according to appendix 9 or 10, wherein the sensor includes an image sensor, a door sensor, and/or a millimeter wave sensor.
[Appendix 12] The information processing method according to any one of appendices 9 to 11, wherein
   the sensor includes a camera, and
   the information processing method comprises:
      upon determining that the content of the abnormality is a suspicious object and that a content of the suspicious object cannot be determined, capturing an enlarged image of the suspicious object by adjusting an orientation, viewing angle, and/or zoom level of the camera; and
      notifying the management server of the enlarged image.
[Appendix 13] The information processing method according to any one of appendices 9 to 12, comprising:
   upon determining that the content of the abnormality relates to a passenger, analyzing a condition of the passenger; and
   notifying the management server of the condition of the passenger.
[Appendix 14] The information processing method according to appendix 13, wherein the condition of the passenger includes an age, gender, posture, behavior, pulse rate, blood pressure, and/or respiratory rate of the passenger.
[Appendix 15] A program configured to cause a computer, as an information processing apparatus capable of communicating with a management server, to execute operations, the operations comprising:
   acquiring sensor information from a sensor installed in a vehicle; and
   upon detecting, from the sensor information, an abnormality in the vehicle, notifying the management server of a content of the abnormality.
[Appendix 16] The program according to appendix 15, wherein the content of the abnormality relates to a suspicious object, an emergency condition of a passenger, an operation impediment, and/or an inquiry from a passenger.
[Appendix 17] The program according to appendix 15 or 16, wherein the sensor includes an image sensor, a door sensor, and/or a millimeter wave sensor.
[Appendix 18] The program according to any one of appendices 15 to 17, wherein
   the sensor includes a camera, and
   the operations comprise:
      upon determining that the content of the abnormality is a suspicious object and that a content of the suspicious object cannot be determined, capturing an enlarged image of the suspicious object by adjusting an orientation, viewing angle, and/or zoom level of the camera; and
      notifying the management server of the enlarged image.
[Appendix 19] The program according to any one of appendices 15 to 18, wherein the operations comprise:
   upon determining that the content of the abnormality relates to a passenger, analyzing a condition of the passenger; and
   notifying the management server of the condition of the passenger.
[Appendix 20] The program according to appendix 19, wherein the condition of the passenger includes an age, gender, posture, behavior, pulse rate, blood pressure, and/or respiratory rate of the passenger.

1. An information processing apparatus capable of communicating with a management server, the information processing apparatus comprising a controller configured to execute operations, the operations comprising:
acquiring sensor information from a sensor installed in a vehicle; and
upon detecting, from the sensor information, an abnormality in the vehicle, notifying the management server of a content of the abnormality.

2. The information processing apparatus according to claim 1, wherein the content of the abnormality relates to a suspicious object, an emergency condition of a passenger, an operation impediment, and/or an inquiry from a passenger.

3. The information processing apparatus according to claim 1, wherein the sensor includes an image sensor, a door sensor, and/or a millimeter wave sensor.

4. The information processing apparatus according to claim 1, wherein
the sensor includes a camera, and
the operations comprise:
upon determining that the content of the abnormality is a suspicious object and that a content of the suspicious object cannot be determined, capturing an enlarged image of the suspicious object by adjusting an orientation, viewing angle, and/or zoom level of the camera; and
notifying the management server of the enlarged image.

5. The information processing apparatus according to claim 1, wherein the operations comprise:
upon determining that the content of the abnormality relates to a passenger, analyzing a condition of the passenger; and
notifying the management server of the condition of the passenger.

6. The information processing apparatus according to claim 5, wherein the condition of the passenger includes an age, gender, posture, behavior, pulse rate, blood pressure, and/or respiratory rate of the passenger.

7. The information processing apparatus according to claim 2, wherein the operations comprise notifying the management server of urgency by determining the urgency from a size of the suspicious object and/or a condition of the passenger.

8. A vehicle having the information processing apparatus according to claim 1 mounted therein.

9. An information processing method by an information processing apparatus capable of communicating with a management server, the information processing method comprising:
acquiring sensor information from a sensor installed in a vehicle; and
upon detecting, from the sensor information, an abnormality in the vehicle, notifying the management server of a content of the abnormality.

10. The information processing method according to claim 9, wherein the content of the abnormality relates to a suspicious object, an emergency condition of a passenger, an operation impediment, and/or an inquiry from a passenger.

11. The information processing method according to claim 9, wherein the sensor includes an image sensor, a door sensor, and/or a millimeter wave sensor.

12. The information processing method according to claim 9, wherein
the sensor includes a camera, and
the information processing method comprises:
upon determining that the content of the abnormality is a suspicious object and that a content of the suspicious object cannot be determined, capturing an enlarged image of the suspicious object by adjusting an orientation, viewing angle, and/or zoom level of the camera; and
notifying the management server of the enlarged image.

13. The information processing method according to claim 9, comprising:
upon determining that the content of the abnormality relates to a passenger, analyzing a condition of the passenger; and
notifying the management server of the condition of the passenger.

14. The information processing method according to claim 13, wherein the condition of the passenger includes an age, gender, posture, behavior, pulse rate, blood pressure, and/or respiratory rate of the passenger.

15. A non-transitory computer readable medium storing a program configured to cause a computer, as an information processing apparatus capable of communicating with a management server, to execute operations, the operations comprising:
acquiring sensor information from a sensor installed in a vehicle; and
upon detecting, from the sensor information, an abnormality in the vehicle, notifying the management server of a content of the abnormality.

16. The non-transitory computer readable medium according to claim 15, wherein the content of the abnormality relates to a suspicious object, an emergency condition of a passenger, an operation impediment, and/or an inquiry from a passenger.

17. The non-transitory computer readable medium according to claim 15, wherein the sensor includes an image sensor, a door sensor, and/or a millimeter wave sensor.

18. The non-transitory computer readable medium according to claim 15, wherein
the sensor includes a camera, and
the operations comprise:
upon determining that the content of the abnormality is a suspicious object and that a content of the suspicious object cannot be determined, capturing an enlarged image of the suspicious object by adjusting an orientation, viewing angle, and/or zoom level of the camera; and
notifying the management server of the enlarged image.

19. The non-transitory computer readable medium according to claim 15, wherein the operations comprise:
upon determining that the content of the abnormality relates to a passenger, analyzing a condition of the passenger; and
notifying the management server of the condition of the passenger.

20. The non-transitory computer readable medium according to claim 19, wherein the condition of the passenger includes an age, gender, posture, behavior, pulse rate, blood pressure, and/or respiratory rate of the passenger.
